(19) United States
(12) Patent Application Publication
(10) Pub. No.: US 2024/0300545 A1
(43) Pub. Date: Sep. 12, 2024

(54) METHOD FOR OPERATING A VEHICLE

(71) Applicant: MERCEDES-BENZ GROUP AG, Stuttgart (DE)

(72) Inventor: Eugen KÄFER, Renningen (DE)

(21) Appl. No.: 18/573,522

(22) PCT Filed: May 23, 2022
(86) PCT No.: PCT/EP2022/063939

§ 371 Date: Dec. 22, 2023

(30) Foreign Application Priority Data
Jun. 25, 2021 (DE) 10 2021 003 284.5

(51) Int. Cl. B60W 60/00; B60W 30/12; B60W 30/14

(52) U.S. Cl. CPC B60W 60/0053; B60W 30/12; B60W 30/143

(57) ABSTRACT

A method for operating a vehicle in the automated driving operation involves continuously monitoring a rear space of the vehicle. If a following vehicle is recorded coming critically close to the vehicle, a warning is output to the following vehicle. If, after a period of time which can be pre-determined, the following vehicle continues to come critically close to the vehicle, a takeover request relating to a driving task is transmitted to a vehicle user of the vehicle.

### BACKGROUND AND SUMMARY OF THE INVENTION

Exemplary embodiments of the invention relate to a method for operating a vehicle in the automated driving operation.

A control unit of a vehicle and a method for protecting the vehicle from a rear-end collision are known from DE 10 2018 204 572 A1. The vehicle has an emergency brake function, which is equipped to automatically cause an emergency braking of the vehicle. The method provides for the control unit to determine that there is an increased probability of an emergency braking being automatically triggered. As a reaction to the latter, at least one warning signal is generated to cause a following vehicle to maintain a sufficiently high safety distance from the vehicle.

In addition, DE 103 28 755 A1 describes a system for avoiding too small a distance from a following vehicle to a vehicle driving ahead, in particular a motor vehicle. For this purpose, it is provided that the vehicle ahead has a device for determining the distance from the following vehicle and for determining the relative speed in relation to the following vehicle, and that a minimum distance is determined on the basis of the determined distance and the relative speed and, if the minimum distance is fallen short of, measures for avoiding a further reduction of the distance are taken to avoid a possible rear-end collision.

Exemplary embodiments of the invention provide a method for operating a vehicle in the automated driving operation.

A method for operating a vehicle in the automated driving operation provides, according to the invention, that a vehicle rear space of the vehicle is continuously monitored. If a following vehicle is recorded coming critically close to the vehicle, a warning is output to the following vehicle and if, after a period of time which can be pre-determined, the following vehicle continues to come critically close to the vehicle, a takeover request relating to a driving task is output to a vehicle user of the vehicle.

By applying the method, the risk of an accident between the vehicle and the following vehicle can be reduced.

The method represents a method of preventively indicating to the following vehicle an adequate distance from the vehicle, such that the distance from the vehicle can be increased and a driver of the following vehicle thus has the possibility of reacting to an unexpected braking maneuver of the vehicle, for example because of an erroneously detected obstacle, of a so-called false object or ghost object. The method thus provides an additional safeguard against a collision with the following vehicle due to incorrect braking of the vehicle driving in the automated driving operation.

The distance between the two vehicles, in particular a safety distance, which makes it possible for the following vehicle to be able to react to an emergency braking of the vehicle, is dependent on speed, because a braking distance of the following vehicle increases with increasing driving speed.

If the method is used, the acceptance of the automated driving operation in vehicles which in some cases have insufficiencies can be increased.

In one embodiment of the method, if the driving task is not taken over after a further period of time which can be pre-determined, a current driving speed of the vehicle is reduced by a value which can be pre-determined, until the following vehicle is no longer coming critically close to the vehicle. For example, no takeover takes place because the vehicle is driving without a driver or a vehicle user is not in a position to manually perform the driving task, for example due to an emergency.

The vehicle reduces its driving speed, in particular, in order to thus signal an offer to the following vehicle to overtake the vehicle, or in order to indicate once again that the following vehicle has come critically close to the vehicle, and is thus not in the position to react to an abrupt braking maneuver of the vehicle. By reducing the speed, a danger of recording ghost targets can furthermore in particular also be reduced.

In a further possible embodiment of the method, after the further period of time has elapsed, the vehicle is controlled such that it moves into a right edge region within its lane in right-hand traffic or moves into a left edge region within its lane in left-hand traffic. In particular, the vehicle continues its automated driving operation with the reduced driving speed. This procedure is thus carried out if the takeover request is not complied with and the vehicle reduces its driving speed by the pre-determined value. In particular, the vehicle drives onto a right or left lane marking and reduces its driving speed, such that it is signaled to the following vehicle to overtake the vehicle, and the following vehicle can no longer come critically close to the vehicle. Thus, the following vehicle no longer represents a rear-end collision risk for the vehicle if the latter brakes abruptly, in particular due to an erroneously recorded object.

In a development of the vehicle, the warning can be output to the following vehicle as a text message on a display unit arranged at the rear of the vehicle. In particular, the text message comprises a request for the following vehicle to increase its distance from the vehicle.

In an alternative or additional embodiment, the warning is output to the following vehicle by means of vehicle-to-vehicle communication. It is thus possible that the driver of the following vehicle is warned directly, i.e., the warning is directly output to the driver of the following vehicle. The warning is thus directly addressed to the driver of the following vehicle.

In a further embodiment of the method, the period of time before the takeover request is output in the vehicle is at least 30 seconds. In other words, the takeover request is output at the earliest 30 seconds after the warning is output to the following vehicle or in the following vehicle. The following vehicle is thus given at least 30 seconds, and thus a sufficient period of time, to react to the warning of the vehicle and to increase the distance from the automated vehicle.

Exemplary embodiments of the invention are explained in more detail in the following with reference to the drawings.

### BRIEF DESCRIPTION OF THE DRAWING FIGURES

Here:

FIG. 1 schematically shows a road portion with two lanes of traffic moving in opposite directions, an automated vehicle, a following vehicle, an approaching vehicle and a ghost object, and

FIG. 2 shows a road portion with two lanes of traffic moving in opposite directions, the automated vehicle, the following vehicle and the ghost object when a method is used to reduce a rear-end collision.

Parts corresponding to one another are provided with the same reference signs in all figures.

### DETAILED DESCRIPTION

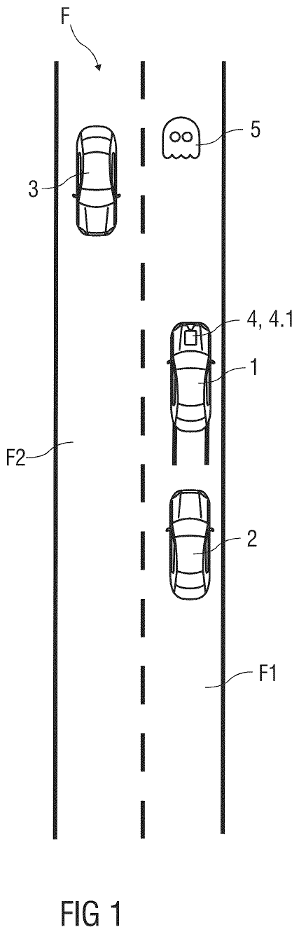

FIG. 1 shows a road portion F with two lanes F1, F2 of traffic moving in opposite directions. A vehicle 1 driving in the automated driving operation and a vehicle 2 following the vehicle 1 are driving in a right lane F1. An approaching vehicle 3 is in a left lane F2.

The vehicle 1 has an assistance system for the automated driving operation, wherein the vehicle 1, in particular the assistance system, carries out a driving task in its entirety, such that a vehicle user can pursue another activity during the automated driving operation.

The assistance system comprises an environment sensor system having a number of recording units in and/or on the vehicle 1, of which at least one is designed as a sensor system 4 and comprises a camera 4.1. The sensor system 4 in the form of the camera 4.1 is arranged in or on the vehicle 1 such that a recording region (not shown in more detail) is directed in front of the vehicle 1, and thus a region of the road portion F lying ahead of the vehicle 1 is recorded.

Using recorded signals of the environment sensor system, and thus also the camera 4.1, obstacles in an environment of the vehicle 1 are detected. By means of a control unit of the environment sensor system, a criticality of a present situation, in particular in relation to a recorded obstacle, is determined. Depending on the determined criticality, in particular if the latter exceeds a pre-determined threshold, a braking maneuver of the vehicle 1 is initiated, for example to reduce a collision risk for the vehicle 1 and the obstacle.

A situation can occasionally occur where a false object 5, i.e., a so-called ghost object, is detected by means of the sensor system 4. Such a false object is an object and thus an obstacle recorded by the sensor system 4, but does not exist in reality. Such a false object 5 leads to a braking maneuver being erroneously initiated in the automated driving operation of the vehicle 1. This means that the vehicle 1 initiates a braking maneuver, e.g., emergency braking, without a reason which can be understood from the outside.

Such a braking maneuver initiated in response to a false object 5, a so-called false positive error, can lead to a rear-end collision between the vehicle 1 and the following vehicle 2. In particular, the risk of a rear-end collision arises if the following vehicle does not maintain a sufficiently large distance from the vehicle 1, and thus comes critically close.

Such a rear-end collision can be avoided with a sufficiently large distance between the vehicle 1 and the following vehicle 2. The vehicle 1 driving in the automated driving operation is not directly able to set the sufficiently large distance from the following vehicle 2, because it is the following vehicle 2 that regulates the distance.

In order to still significantly reduce the risk of such a rear-end collision based on an insufficient distance between the vehicle 1 and the following vehicle 2, a method described in the following is provided.

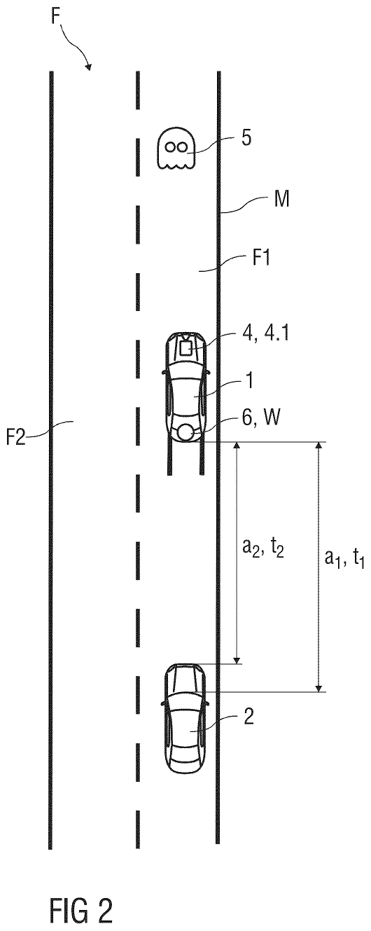

FIG. 2 shows a road portion F having two lanes F1, F2 of opposite moving traffic, wherein the vehicle 1 is driving in the automated driving operation in the right lane F1 and a following vehicle 2 is driving behind the vehicle 1, said following vehicle coming critically close to the vehicle 1 from behind.

The environment sensor system comprises at least one recording unit, for example a radar-based recording unit, which monitors a vehicle rear space, i.e., a region behind the vehicle 1, at least during the automated driving operation of the vehicle 1.

If the following vehicle 2 is detected using recorded signals of the environment sensor system, a distance a₁ and thus a time gap t₁ is determined, which the following vehicle 2 usually requires to avoid a rear-end collision if the vehicle 1 initiates false braking due to a recorded false object 5. This distance a₁ and the time gap t₁ can in particular be dependent on speed.

If the following vehicle 2 has come critically close to the vehicle 1 in such a way that a further distance a₂ and a further time gap t₂ are insufficient for a rear-end collision between the following vehicle 2 and the vehicle 1 to be avoided when said vehicle 1 initiates false braking due to a recorded false object 5, a warning is output to the following vehicle 2 by the vehicle 1.

In one embodiment, the warning W of the vehicle is output to the following vehicle 2 by means of a displayed text message. For this purpose, a display unit 6 is arranged in the rear region of the vehicle 1. In particular, the text message contains a request to increase the current further distance a₂ of the following vehicle 2 from the vehicle 1 if the distance a₁, and thus the time gap t¹ is fallen short of.

As an alternative or in addition, the warning W is transmitted to the following vehicle 2 and output in the latter by means of vehicle-to-vehicle communication. A driver of the following vehicle 2 is thus directly warned, in particular via an assistance system for active safety.

If the following vehicle 2 continues to come critically closer to the vehicle 1, whereby the spacing a₁ and the time gap t₁ are fallen short of, a takeover request is output in the vehicle 1 after a period of time which can be pre-determined, for example of 30 seconds, such that a vehicle user of the vehicle 1 carries out a driving task of the vehicle 1 manually.

If the driving task has not been taken over after a further period of time has elapsed, for example because there is no vehicle user in the vehicle 1 or the vehicle user cannot carry out the driving task due to an emergency, the vehicle 1 reduces its current driving speed by a pre-determined value. It is thus signaled to the following vehicle 2 to overtake the vehicle 1 while taking into account at least one contrary stream of traffic.

In addition, it can be provided that the vehicle 1 moves into the region of a right lane marking M within its lane F1 after the further period of time has elapsed, and continues its automated driving operation there with the reduced driving speed. Because it moves into the region of the right lane marking M and because of the reduced driving speed, the following vehicle 2 is required to carry out an overtaking maneuver without endangering further traffic participants.

If the following vehicle 2 has overtaken the vehicle 1 or the further distance a₂ increases to at least the distance a₁, the vehicle 1 positions itself centrally in relation to its right lane F1, and increases the current driving speed to a driving speed permissible for the automated driving operation, in particular to a driving speed which applies to a road portion.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method comprising:
operating a vehicle in an automated driving operation, wherein during the operating of the vehicle in the automated driving operation, the method further comprises
continuously monitoring a vehicle rear space of the vehicle;
outputting a warning to a following vehicle responsive to the continuously monitoring indicating that the following vehicle is coming critically close to the vehicle; and
transmitting, responsive to the following vehicle continuing to come critically close to the vehicle after a period of time, a takeover request relating to a driving task to a vehicle user of the vehicle.

8. The method of claim 7, wherein, responsive to a determination that the driving task is not taken over after a further period of time, a current driving speed of the vehicle is reduced by a value until the following vehicle is no longer coming critically close to the vehicle.

9. The method of claim 8, wherein, after the further period of time has elapsed, the vehicle is controlled such that the vehicle moves into a right edge region within the vehicle's lane in right-hand traffic or into a left edge region within the vehicle's lane in left-hand traffic.

10. The method of claim 7, wherein the warning is output to the following vehicle as a text message on a display unit arranged at a rear of the vehicle.

11. The method of claim 7, wherein the warning is transmitted to the following vehicle by a vehicle-to-vehicle communication.

12. The method of claim 7, wherein the period of time before the takeover request is output to the vehicle is at least 30 seconds.
